(19) United States
(12) Patent Application Publication
(10) Pub. No.: US 2018/0060341 A1
(43) Pub. Date: Mar. 1, 2018

(54) Querying Data Records Stored On A Distributed File System

(71) Applicant: PAYPAL, INC., San Jose, CA (US)

(72) Inventors: Haifeng Wu, Shanghai (CN); Pengshan Zhang, Shanghai (CN); Wei Shen, Shanghai (CN)

(21) Appl. No.: 15/254,467

(22) Filed: Sep. 1, 2016

(51) Int. Cl. G06F 17/30

(52) U.S. Cl. CPC G06F 17/30106; G06F 17/30094; G06F 17/30194

(57) ABSTRACT

Systems and methods for query large database records are disclosed. An example method includes: obtaining a first search query including a first keyword; accessing a relational database that stores a mapping between one or more keywords and a data record location associated with a distributed file system (DFS). The data record location identifies a location on the DFS at which a data record matching the one or more keywords is stored. The method also includes, determining, using a relational database, a first data record location based on the first keyword; identifying a first data record based on the first data record location; and providing the first data record as a matching record responsive to the first search query.

### TECHNICAL FIELD

The present disclosure relates generally to processing database queries, and in particular, to querying data records stored on a distributed file system.

### BACKGROUND

Data records stored in a Hadoop database are often quite large and thus may require significant time and processing power to load for the purpose of a data query. Executing search queries in an ad hoc or streaming fashion against a Hadoop database is therefore often time consuming. To provide quicker data access, Hadoop data records can be duplicated in a relational database. This, however, may double the storage space.

There is therefore a need for a device, system, and method, which enable access to data records stored on a distributed file system, e.g., a Hadoop system, in a less time- and/or power-consuming fashion than what is currently known.

### BRIEF DESCRIPTION OF THE FIGURES

FIG. 1 is a schematic view illustrating an embodiment of a system for querying data records stored on a distributed file system.

FIG. 2A is a schematic view illustrating an embodiment of a second system for querying data records stored on a distributed file system.

FIG. 2B is a schematic view illustrating an embodiment of relationship mappings between search keywords and data records stored on a distributed file system.

FIG. 3A is a flow chart illustrating an embodiment of a method for querying data records stored on a distributed file system.

FIG. 3B is a flow chart illustrating an embodiment of a second method for querying data records stored on a distributed file system.

FIG. 4 is a schematic view illustrating an embodiment of a computing device.

FIG. 5 is a schematic view illustrating an embodiment of a SQL system.

FIG. 6 is a schematic view illustrating an embodiment of a distributed file system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for querying large unstructured data records stored on a distributed file system, for example, a Hadoop distributed file system (HDFS). A Hadoop system may store a large amount of data across a plurality of data nodes, with a predefined degree of data redundancy. Using Structured Query Languages (SQLs) to directly search data located in a Hadoop system, however, may have severe drawbacks.

For example, an HDFS system often stores unstructured data (e.g., large text chunks, audio files, and movie clips), which are not optimized for query and access by SQLs, as SQL queries perform sometimes under the assumption that underlying data are largely well-structured (e.g., by way of data tables). Executing an SQL statement against an HDFS system may therefore result in prolonged response time, e.g., minutes or event hours, causing real-time operational analytics and traditional operational applications, e.g., web, mobile, and social media applications as well as enterprise software applications to “hang” (become unresponsive).

In some implementation, to enable SQL queries (e.g., on an ad hoc basis or a batch processing basis) against an HDFS, an intermediary relational database can be implemented to store mapping between one or more SQL search keywords and the locations of matching data records in a Hadoop database as follows:
[search keyword 1; (file path, offset, and length)]; or
[search keyword 1, search keyword 2, . . . , search keyword n; (file path, offset, and length)]; or
[search keyword 1, search keyword 2, . . . , search keyword n; (file path 1, offset 1, and length 1), and (file path 2, offset 2, and length 2)];

The (file path, offset, and length) is a location pointer that may provide direct access to a matching Hadoop data record. Once the respective locations of matching data records are determined, ad hoc data retrievals can be executed, e.g., within 100-200 milliseconds, to interact with real time analytics or traditional operational applications. Alternatively, batch data retrievals can be executed, e.g., to take advantage of the HDFS system's high data throughput performance.

The systems and methods described in the present disclosure can provide a variety of technical advantages.

First, better search performance can be provided even when the matching data are unstructured data and are stored across multiple data servers. Second, ad hoc SQL queries may be executed and search results obtained with faster response time (e.g., 100-200 milliseconds as opposed to minutes or hours). Third, an HDFS may be enabled to supply data to real-time operational analytics and traditional operational applications, e.g., web, mobile, and social media applications. Fourth, mapping relationships can be updated independently from data records updated in an HDFS and in a batching processing fashion, e.g., on a daily basis.

Additional details of implementations are now described in relation to the Figures.

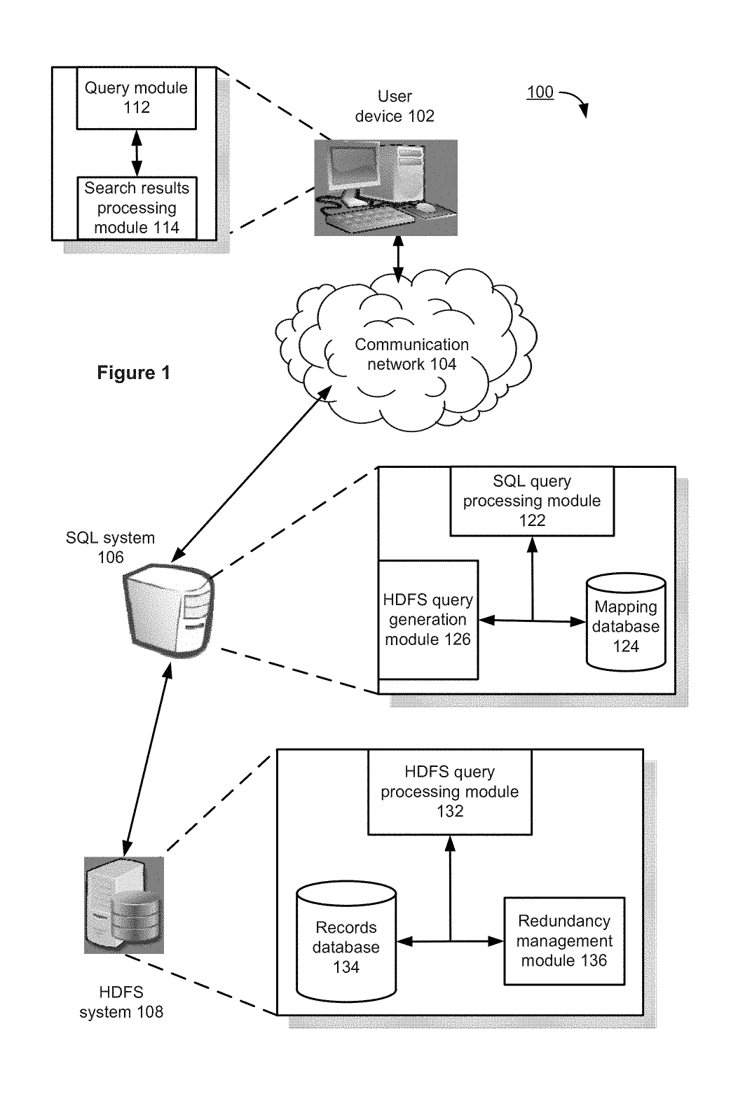

FIG. 1 is a schematic view illustrating an embodiment of a system 100 for querying data records stored on a distributed file system. The system 100 may comprise or implement a plurality of servers and/or software components that operate to perform various technologies provided in the present disclosure.

As illustrated in FIG. 1, the system 100 may include a user device 102, an SQL system 106, and an HDFS system 108 in communication over a communication network 104. In the present disclosure, a user device 102 may be a mobile device, a smartphone, a laptop computer, a notebook computer, a mobile computer, a wearable computing device, or a desktop computer.

In one embodiment, the user device 102 collects one or more keywords from a user and requests, such as responsive to search results, data records that are stored on the HDFS system 108 and match the one or more keywords. For example, when a user performs a search of the phrases “Money transfer” and “PayPal,” the user device 102 may directly or indirectly (e.g., through the SQL system 106) search for data records stored in a Hadoop data storage system that include the phrases “Money transfer” and “PayPal,” their synonyms (e.g., “fund transfer” and “PP”), or any other variants (“S transfer” and “PAYPAL”) that may be determined (based on one or more characters, strings, or content comparison algorithms) as matching the user-supplied phrases. In one embodiment, the user device 102 includes a query module 112 and a search results processing module 114.

The query module 112 enables a user to launch, within a software application (e.g., a web application) search queries against data records stored on the HDFS system 108 through the SQL system 106. For example, the query module 112 may collect user-provided search parameters (e.g., characters, words, phrase, sentences, audio, video, or images) and request that the SQL system 106 provide the HDFS locations at which matching data records are located. An HDFS location may include an absolute location or a relative location, for example, “Data Node ?\Root\Matching file_1.dox” (with the symbol “?” representing any single character, e.g., A-Z and a-z, or number, e.g., 0-9) or “Data Node1\Root\, begin at 200K, and file size=65 MB,” respectively.

In the event that the SQL server 104 cannot locate any matching locations, the query module 112 may determine that no matching record exists on the HDFS system 108 and return empty search results to the user who executed the query, thereby concluding (or short-circuiting) the search process. This “short-circuit” feature is technically advantageous. For example, in these “no matching record” situations, having determined, based on the mapping database 124, that no matching record exists, the SQL system 106 may not need to execute the original search query against the HDFS system 108 at all, which would have taken more response time to return the same search results—or lack thereof—to the requesting user.

This is technically significant, because the HDFS system 108 may store a large number (e.g., hundreds and thousands) of data records across a similarly large number of data nodes and a search through all these data nodes and the data records stored thereon would have taken more time.

Alternatively, in the event that the SQL server 106 does identify one or more locations at which matching data records may be located, the query module 122 may proceed to retrieve the matching data records from the identified locations in real-time or may place the data retrieval requests as part of a batch processing job to be processed in a batch fashion. These technologies are technically advantageous for at least the following reasons.

First, searching specific locations (e.g., “Node 1\Root\Directory HB\Palo Alto Office\Patent files\”) of an HDFS system (even on a real time basis) can take significantly less time than searching keywords directly against the HDFS system (e.g., search data nodes 1-30 for records including the phrase “Palo Alto”).

Second, if a user search or record update is performed as a batch job along with a large number of other user data access or modification requests, overall performance can be improved, as HDFS systems are specifically tailored to process high volume data with high efficiency and fault tolerance while requiring minimal user intervention.

In one embodiment, the communication network 104 interconnects a user device 102, a SQL system 106, and a HDFS system 108. In some implementations, the communication network 104 optionally includes the Internet, one or more local area networks (LANs), one or more wide area networks (WANs), other types of networks, or a combination of such networks.

Once matching search results are returned by the SQL system 106 or by the HDFS system 108, the search results processing module 114 may sort, rank, format, and modify search results and present the processed search results, with or without formality or substantive modification, within a software application (e.g., a web browser) on the user device 102 for review by a user.

In one embodiment, the SQL system 106 stores mappings between search keywords and HDFS locations of the matching data records. The SQL system 106 may also generate one or more specific HDFS queries based on an original user search query, in order to retrieve the matching data records from the HDFS system 106. The SQL system 106 may include a SQL query processing module 122, a mapping database 124, and an HDFS query generation module 126.

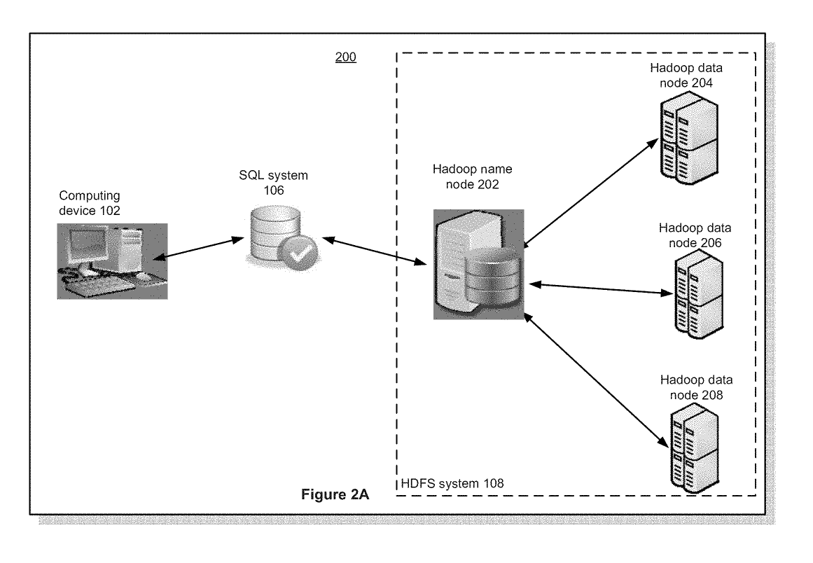

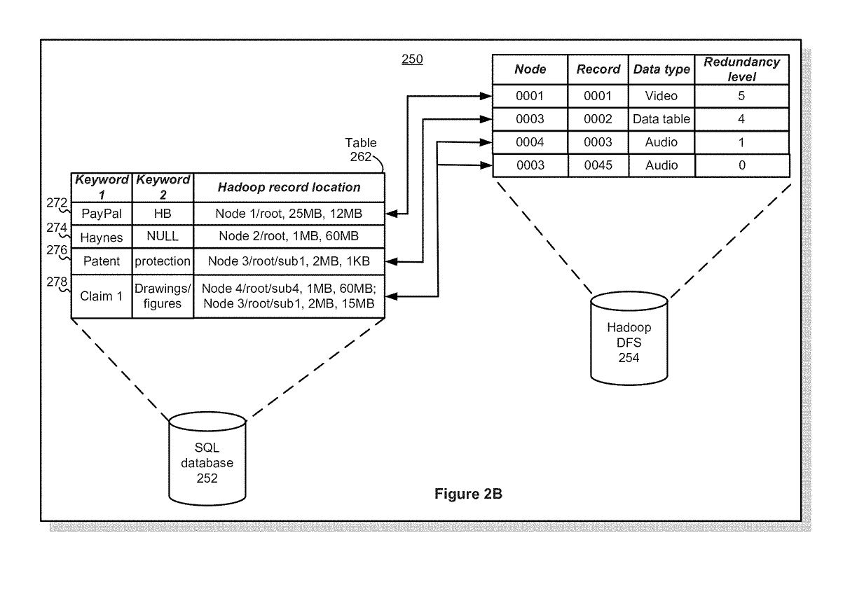

The mapping database 124 may store mapping relationships between user-provided search keywords and data record locations at which matching data records are stored on a distributed file system, e.g., the HDFS system 106. The mapping relationships may include one-to-one relationships, many-to-many relationships, many-to-one relationships, one-to-many relationships, and/or a combination thereof. More details concerning the mapping database 124 are explained with reference to FIG. 2B.

The SQL query processing module 122 may identify matching data record locations based the mapping database 124. For example, after receiving a user search including a single keyword “Weather,” the SQL query processing module 122 may search within the mapping database 124 to identify locations where data records including the keyword “Weather” or its equivalents (e.g., synonym) are located and provide the matching locations to the HDFS query generation module 126.

Based on one or more specific matching locations provided by the SQL query processing module 122, the HDFS query generation module 126 may execute a retrieval of data records at the specification locations as part of a batch data retrieval job or as a standalone individual query.

In one embodiment, the HDFS system 108 maintains a high number of large data records (e.g., 50000 records, each of which is between 32 MB and 64 MB in size) and provides (and updates) data records as requested by the SQL system 106. The HDFS system 108 may include an HDFS query processing module 132, a records database 134, and a redundancy management module 136.

The HDFS query processing module 132 may process one or more user search queries, e.g., by retrieving data records from matching locations identified by the SQL system 106, either on a batch basis or on an ad hoc basis. The records database 134, although for the ease of illustration is shown in FIG. 1 as one piece, may include a predefined number of data nodes managed by a name node for storing large data records across the data nodes. More details concerning the map records ping database 134 are explained with reference to FIG. 2B.

FIG. 2A is a schematic view illustrating an embodiment of a system 200 for querying data records stored on a distributed file system. The system 200 may comprise or implement a plurality of servers and/or software components that operate to perform various technologies provided in the present disclosure.

As shown in FIG. 2A, the system 200 may include a computer device 102, an SQL system 106, and a Hadoop name node 202 that manages a predefined number of Hadoop data nodes, e.g., the data nodes 204, 206, and 208. The Hadoop name node 202 and its associated data nodes 204, 206, and 208 may be collectively referred to as a Hadoop data storage system, e.g., the HDFS system 108.

When a user executes a search query “PayPal” on the computing device 102, the system 200, in some implementations, does not executes the search query directly against the HDFS system 108, because, as explained above, searching a Hadoop data store system directly may result in prolonged response time and/or processing power, causing the user application requesting the search to become unresponsive. For example, a web browser in which a user is requesting search results matching the keyword “PayPal” may appear frozen because it may take several minutes locating the matching search results directly from the HDFS system 108.

In some implementations, therefore, the computing device 102 executes the search query “PayPal” against a mapping database stored on the SQL system 106. The mapping database may be a relational database that has been optimized for user queries against large data records. For example, the mapping database may use inverted indexing technologies to map from a search keyword (e.g., “PayPal”) to one or more locations at which data records matching the search keyword are located on the HDFS system 108.

Implementing the mapping database as a relational database is technically advantageous for at least the following reasons. First, data redundancy can be kept low, as even when multiple tables are used, a data entry is stored once. Second, complex user search queries coded using SQL programming can be enabled, e.g., SELECT*FROM mapping_table_1 WHERE search records having “PayPal” AND the record_creation is BEFORE “Jan. 12, 2011” AND (the last_update is AFTER “May 26, 2016” OR the creator IS “liua”). Third, the mappings of search keywords to different subsets of data records may be stored in different tables, for example, for the purpose of access control. Fourth, new mapping relationships may be added and existing relationships modified e.g., by way of adding new tables or deleting entries form existing tables, without affecting other data.

The HDFS system 108 may be a Java-based file system designed to span large clusters of data servers. The HDFS system 108 may provide scalability by adding new data nodes and may automatically re-distribute existing data onto the new data nodes to achieve data balancing. Computing tasks, e.g., data retrieval requests, may be distributed among multiple applicable data nodes and performed in parallel. By distributing storage and computation load across different nodes, the combined storage resource can grow linearly with data demand while remaining economical at every amount of storage.

Using the HDFS system 108 to store a large amount of data records, each of which is also itself large in size can provide the following advantages. First, the name node 202 may take into account a data node's physical or network location when allocating data to the data node. For example, the HDFS system may choose the data node 204, which is located in a same local area network as the computing device 102 to store new data records provided by the computing device 102, to reduce transmission overhead, e.g., when the performance of a computer network connecting the data node 206 and the computing device 102 is below an acceptable level or has suffered an outage. Second, the name node 202 may dynamically monitor and diagnose the health of the data nodes 204-208 and re-balance data records stored thereon. Third, the name node may provide, e.g., through the redundancy management model 134, data redundancy and support high data availability by storing a same data record (or a portion thereof) on several different nodes. Fourth, the HDFS system 108 can be automated and thus require minimal user invention, e.g., when executing batch data processing jobs, allowing a single user to monitor and control a cluster of hundreds or even thousands of data nodes. Sixth, data processing tasks may be “moved” to and executed on the data nodes where the matching records reside (e.g., are stored), significantly reducing network I/O and providing high aggregate bandwidth.

FIG. 2B is a schematic view illustrating an embodiment of relationship mappings 250 between search keywords and data records stored on a distributed file system. The SQL database 252 can be the mapping database 124 shown in FIG. 1; and the Hadoop DFS 254 can be the HDFS system 108 shown in FIGS. 1 and 2.

The SQL database 252 may include one or more mapping tables. The mapping table 262 stores mapping relationships between one or more keywords to a relative data location on an HDFS system.

A mapping relationship may be a one-to-one (e.g., one keyword to one data record) relationship. For example, the mapping 274 identifies a single data record stored at the location “Node 2/root, 1 MB, 60 MB” as matching the keyword “PayPal.”

A mapping relationship may be a many-to-one (e.g., two or more keywords to one data record) relationship. For example, the mapping 272 identifies a data record stored at the location “Node 1/root, 25 MB, 12 MB” as including the keyword “PayPal” and the keyword “HB”; and the mapping 276 identifies a data record stored at the location “Node 3/root/sub1, 2 MB, 1 KB” as matching the keyword “Patent” and the keyword “protection.”

A mapping relationship may be a many-to-many (e.g., two or more keywords to two or more data records) relationship. For example, the mapping 278 identifies two data records stored at the locations “Node 4/root/sub4, 1 MB, 60 MB” and “Node 3/root/sub1, 2 MB, 15 MB” as matching the keyword “Claim 1” and the keyword “Drawings” (or alternatively the keyword “figures”).

Note that the data record locations identified in the table 262 include relative locations, such as represented by node name/file path, recording starting location or offset, record length. Implementing the data record locations using relative locations are technically advantageous. First, data records stored on HDFS are often accessed (e.g., read) at a high frequency, but modified (e.g., written) at a low frequency, rendering the data size to almost a constant value. Second, the node name/file path can be automatically generated when a name node distributes or redistributes a data record, reducing the resource needed to separately generate and track the node name/file path portion of a data record location.

Note that some data records stored on the Hadoop DFS 254 are associated with a redundancy level, which may indicate the total number of available copies of a particular data record. In some implementations, a name node maintains not only a redundancy level, but also the locations where the redundancies are located. For example, the record 0003 may have one additional copy stored at “Node 10/root/sub2, 5 MB, 1 KB,” other than the location “Node 3/root/sub1, 2 MB, 1 KB,” as registered in the table 262. The combination of the Hadoop record locations maintained in the SQL database 252 (e.g., “Node 3/root/sub1, 2 MB, 1 KB”) with the redundancy locations managed by a name node (“Node 10/root/sub2, 5 MB, 1 KB”) may further extend the ability to search a matching data record as well the redundant copes thereof, responsive to a user-provided query.

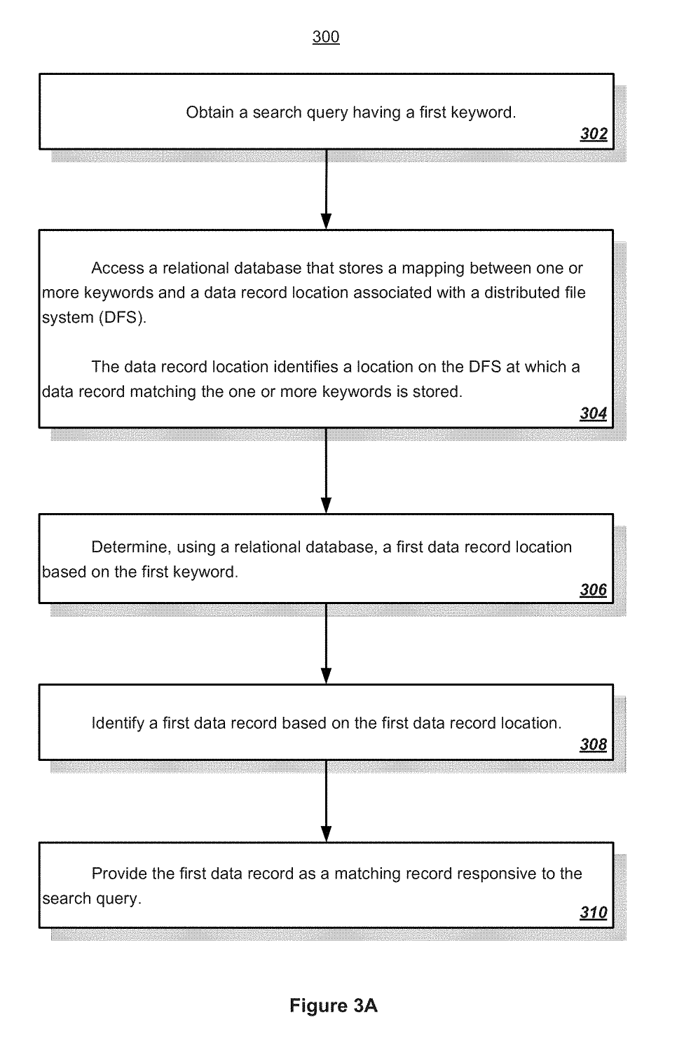

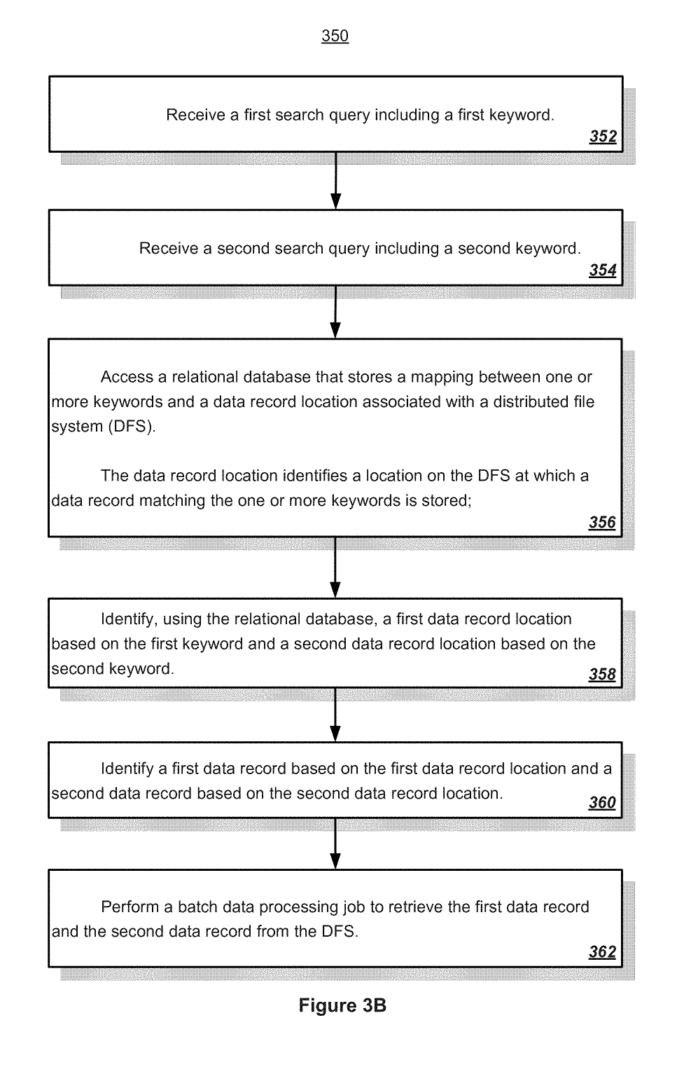

FIG. 3A is a flow chart illustrating an embodiment of a method 300 for querying data records stored on a distributed file system. The user device 102, for example, when programmed in accordance with the technologies described in the present disclosure, can perform the method 300.

In some implementations, the method 300 includes obtaining (302) a first search query including a first keyword; and accessing (304) a relational database that stores a mapping between one or more keywords and a data record location associated with a distributed file system (DFS). The data record location identifies a location on the DFS at which a data record matching the one or more keywords is stored. The method 300 also includes determining (306), using the relational database, a first data record location based on the first keyword; identifying (308) a first data record based on the first data record location; and providing (310) the first data record as a matching record responsive to the first search query.

In some implementations, the mapping is an inverted index mapping from the one or more keywords to the data record location. For example, as explained with reference to FIGS. 1 and 2B, the mapping table may be invertedly-indexed based on search keywords, so that data record locations maybe determined faster.

In some implementations, a matching record is retrieved as part of a batch job, rather than a standalone data retrieval job, for example, to take advantage of an HDFS system's batch and parallel processing capabilities. The method 300 therefore may further comprise retrieving, as part of a batch data processing, the first data record from the DFS.

In some implementations, a user query includes two or more keywords and thus a many (keywords)-to-one (data record) mapping is used to determine the location of a matching data record. For example, the search query may include a second keyword other than the first keyword; and the method 300 may further comprise determining, using the relational database, the first data record location based on the second keyword.

In some implementations, multiple user queries are executed and matching results to the multiple user queries are returned after a batch processing at an HDFS system. For example, the method 300 may further comprise obtaining a second search query including a second keyword; determining, using the relational database, a second data record location based on the second keyword; identifying a second data record based on the second data record location; executing a batch data retrieval job to retrieve the first data record and the second data record; and providing the second data record as a matching record responsive to the second search query.

In some implementation, a preliminary search result is provided before any actual data retrieval takes place, e.g., in order to provide a faster response time. The method 300 may therefore further comprise acknowledging that the first search query has a first matching record store on the DFS. In some implementations, the acknowledging occurs as part of a stream data processing job.

For example, as shown in FIG. 2B, the mapping 278 stored in the table 262 identifies that there are two HDFS records mapping the user query “Claim 1 and Drawings.” To retrieve the two matching records in full, however, may take longer than a predefined time frame (e.g., 100 ms), due to the large sizes of the matching records (e.g., 60 MB and 15 MB, respectively).

The user executing the search query “Claim 1 and Drawings,” however, may prefer to know that at least one matching record exists first, before beginning to review any matching records in full. In this case, therefore, the system 100 may provide an acknowledgement to the user informing her that two matching records exist and may further offer the user the option to retrieve these two matching records (or a portion thereof) on a real time basis or to retrieve these two matching records in a batch process job.

FIG. 3B is a flow chart illustrating an embodiment of a method 350 for querying data records stored on a distributed file system. The user device 106, for example, when programmed in accordance with the technologies described in the present disclosure, can perform the method 350.

In some implementations, the method 350 includes receiving (352) a first search query including a first keyword; receiving (354) a second search query including a second keyword; and accessing (356) a relational database that stores a mapping between one or more keywords and a data record location associated with a distributed file system (DFS). The data record location identifies a location on the DFS at which a data record matching the one or more keywords is stored. The method 350 may also include determining (358), using the relational database, a first data record location based on the first keyword and a second data record location based on the second keyword; identifying (360) a first data record based on the first data record location and a second data record based on the second data record location; and performing (362) a batch data processing job to retrieve the first data record and the second data record from the DFS.

In some implementations, once matching data records are identified by their respective locations, an HDFS name node may execute several data retrievals across different data nodes in parallel to provide an increased data throughput. The method 350 may therefore include retrieving the first data record from a first data node associated with the DFS; and retrieving the second data record from a second data node associated with the DFS. Alternatively, matching data records may be retrieved from a single node if the name node determines that the overall performance may be increased, for example, when a different node on which a redundancy is store in unavailable or suffering from a performance degradation. In some implementations, therefore, the method 350 includes retrieving the first data record and the second data record from a same data node associated with the DFS.

In some implementations, the method 350 includes, responsive to determining the first data record location and the second data record location, acknowledging that matching records exist for the first search query and the second search query. In some implementations, receiving the first search query and receiving the second search query are part of a stream data processing job.

In some implementations, the first data record and the second data record are greater than a predefined file size, e.g., 64 MB or greater.

In some implementations, once matching data records are identified by their respective locations, the retrievals of these matching data records are registered as part of a batch processing job and their executions deferred to the name node in an HDFS system, because the name node may have a more comprehensive overview of where a matching data record and its redundancy copies are stored and a better knowledge of how to perform these retrievals to provide an optimal throughput rate. Therefore, in some implementations, performing the batch data processing job comprises requesting a name node to retrieve the first data record based on the first data record location and to retrieve the second data record based on the second data record location.

In some implementations, the first query includes a request to modify the first data record based on the first keyword.

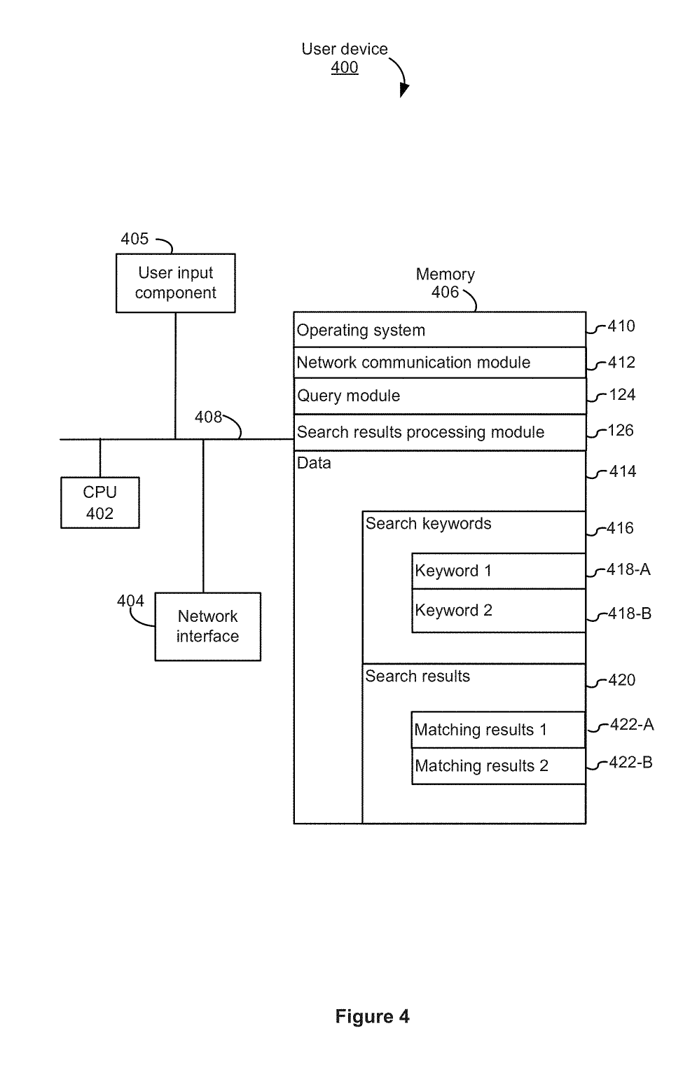

FIG. 4 is a schematic view illustrating an embodiment of a computing device 400, which can be the device 102 shown in FIG. 1. The device 400 in some implementations includes one or more processing units CPU(s) 402 (also referred to as hardware processors), one or more network interfaces 404, a memory 406, and one or more communication buses 406 for interconnecting these components. The communication buses 406 optionally include circuitry (sometimes called a chipset) that interconnects and controls communications between system components. The memory 406 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 406 optionally includes one or more storage devices remotely located from the CPU(s) 402. The memory 406, or alternatively the non-volatile memory device(s) within the memory 406, comprises a non-transitory computer readable storage medium. In some implementations, the memory 406 or alternatively the non-transitory computer readable storage medium stores the following programs, modules and data structures, or a subset thereof:
an operating system 410, which includes procedures for handling various basic system services and for performing hardware dependent tasks;
a network communication module (or instructions) 412 for connecting the device 400 with other devices (e.g. the SQL system 106 or the HDFS system 108) via one or more network interfaces 404 (wired or wireless) or via the communication network 104 (FIG. 1);
a query module 124 for enabling a user to launch search queries against data records stored on an HDFS system, e.g., the system 108;
a search results processing module 126 for storing, ranking, presenting, and search results for a user and for enabling a user to modify data records stored on an HDFS system, e.g., the system 108; and
data 414 stored on the device 400, which may include:
   one or more user-provided search keywords 416, for example, keyword 418-A (e.g., “Hadoop”) and keyword 418-B (e.g., “SQL server”); and
   one or more search results matching a user-provided keyword, for example, the matching results 422-A and the matching results 422-B.

The device 400 may also include one or more user input components 405, for example, a keyboard, a mouse, a touchpad, a track pad, and a touch screen, for enabling a user to interact with the device 400.

In some implementations, one or more of the above identified elements are stored in one or more of the previously mentioned memory devices, and correspond to a set of instructions for performing functions described above. The above identified modules or programs (e.g., sets of instructions) need not be implemented as separate software programs, procedures or modules, and thus various subsets of these modules may be combined or otherwise re-arranged in various implementations. In some implementations, the memory 406 optionally stores a subset of the modules and data structures identified above. Furthermore, the memory 406 may store additional modules and data structures not described above.

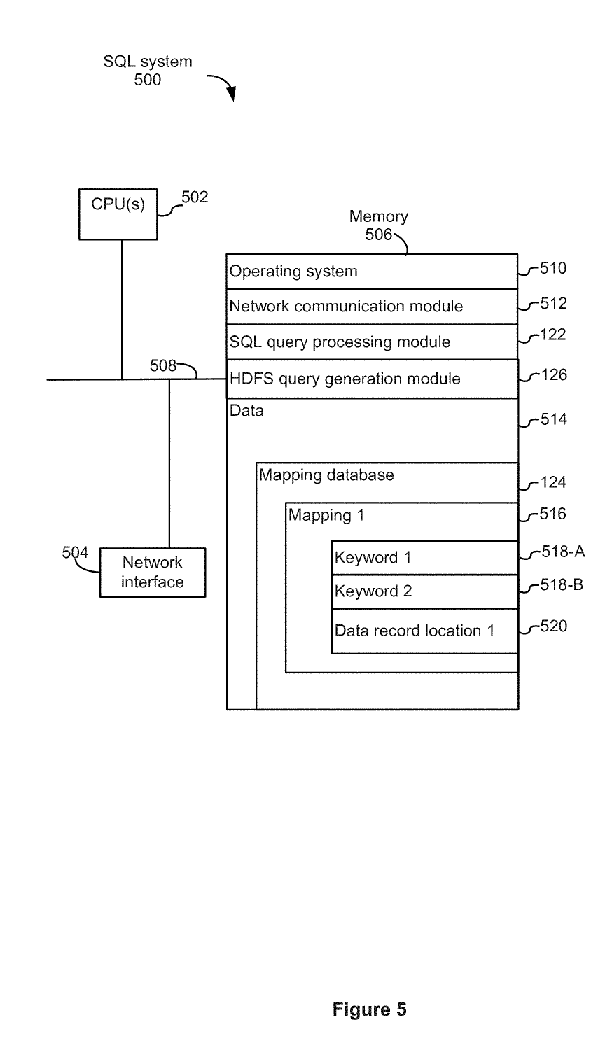

FIG. 5 is a schematic view illustrating an embodiment of a SQL system 500, which can be the SQL system 106 shown in FIG. 1. The system 500 in some implementations includes one or more processing units CPU(s) 502 (also referred to as hardware processors), one or more network interfaces 504, a memory 506, and one or more communication buses 508 for interconnecting these components. The communication buses 508 optionally include circuitry (sometimes called a chipset) that interconnects and controls communications between system components. The memory 506 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 506 optionally includes one or more storage devices remotely located from the CPU(s) 502. The memory 506, or alternatively the non-volatile memory device(s) within the memory 506, comprises a non-transitory computer readable storage medium. In some implementations, the memory 506 or alternatively the non-transitory computer readable storage medium stores the following programs, modules and data structures, or a subset thereof:
an operating system 510, which includes procedures for handling various basic system services and for performing hardware dependent tasks;
a network communication module (or instructions) 512 for connecting the system 500 with other devices (e.g., the user device 102 or the HDFS system 108) via one or more network interfaces 504;
a SQL query processing module 122 for processing a user-provided SQL query and for identifying matching data record locations based the mapping database 124;
an HDFS query generation module 126 for generating a batch data processing job to retrieve data records stored on a distributed file system based on specific data record locations; and
data 514 stored on the system 500, which may include:
   a mapping database 124 for storing, e.g., one-to-one, many-to-many, many-to-one, one-to-many, or a combination thereof, relationship mappings between user-provided search keywords and data record locations at which matching data records are stored on a distributed file system, e.g., the HDFS system 106.

For example, the mapping 516 identifies that a data record stored at the data record location 520 matches (e.g., includes) the keywords 518-A and 518-B.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 506 optionally stores a subset of the modules and data structures identified above. Furthermore, the memory 506 may store additional modules and data structures not described above.

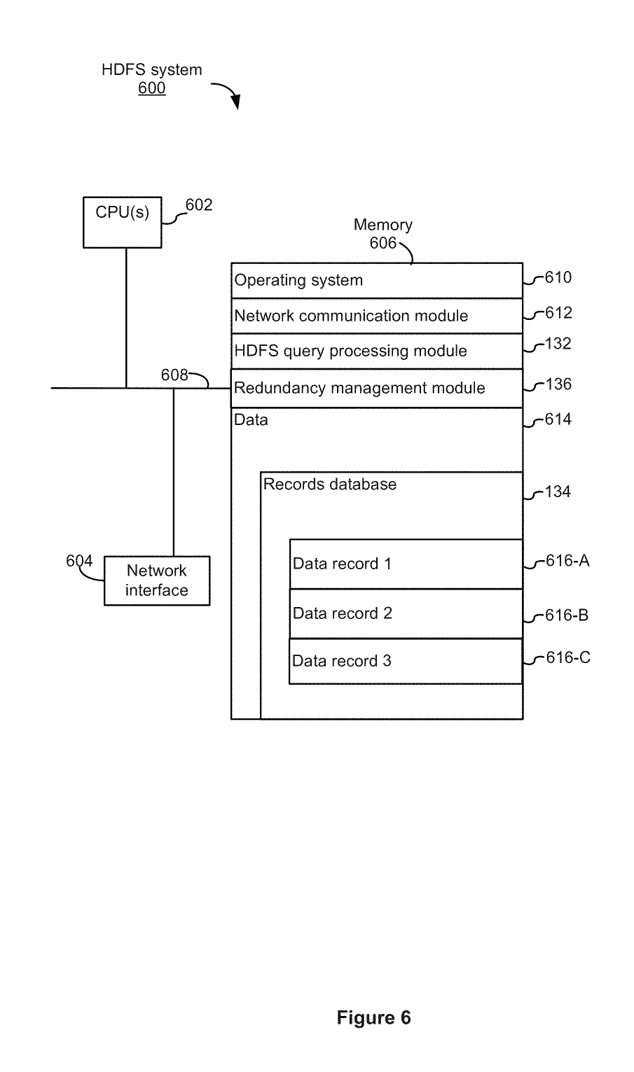

FIG. 6 is a schematic view illustrating an embodiment of a distributed file system 600, which can be the HDFS system 108 shown in FIG. 1. The system 600 in some implementations includes one or more processing units CPU(s) 602 (also referred to as hardware processors), one or more network interfaces 604, a memory 606, and one or more communication buses 608 for interconnecting these components. The communication buses 608 optionally include circuitry (sometimes called a chipset) that interconnects and controls communications between system components. The memory 606 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 606 optionally includes one or more storage devices remotely located from the CPU(s) 602. The memory 606, or alternatively the non-volatile memory device(s) within the memory 606, comprises a non-transitory computer readable storage medium. In some implementations, the memory 606 or alternatively the non-transitory computer readable storage medium stores the following programs, modules and data structures, or a subset thereof:
an operating system 610, which includes procedures for handling various basic system services and for performing hardware dependent tasks;
a network communication module (or instructions) 612 for connecting the system 600 with other devices (e.g., the user device 102 or the SQL system 106) via one or more network interfaces 604;
an HDFS query processing module 132 for processing one or more search queries as a batch job;
a redundancy management module 136 for maintaining a predefined amount of data redundancy across one or more data nodes included in the HDFS system; and
data 614 stored on the system 600, which may include:
a records database 134 for storing, using one or more data nodes, large size data records (e.g., 64 MB or more per data record), for example, the data records 616A, 616-B, and 616-C.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 606 optionally stores a subset of the modules and data structures identified above. Furthermore, the memory 606 may store additional modules and data structures not described above.

Although FIGS. 4, 5, and 6 show a “user device 400,” a “SQL system 600,” and an “HDFS system,” respectively, FIGS. 4, 6, and 6 are intended more as functional description of the various features which may be present in computer systems than as a structural schematic of the implementations described herein. In practice, and as recognized by those of ordinary skill in the art, items shown separately could be combined and some items could be separated.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
obtaining a first search query including a first keyword;
accessing a relational database that stores a mapping between one or more keywords and a data record location associated with a distributed file system (DFS), wherein the data record location identifies a location on the DFS at which a data record matching the one or more keywords is stored;
determining, using the relational database, a first data record location based on the first keyword;
identifying a first data record based on the first data record location; and
providing the first data record as a matching record responsive to the first search query.

2. The method of claim 1, wherein the mapping is an inverted index mapping from the one or more keywords to the data record location.

3. The method of claim 1, further comprising: retrieving, as part of a batch data processing, the first data record from the DFS.

4. The method of claim 1, wherein the search query includes a second keyword different from the first keyword; and further comprising: determining, using the relational database, the first data record location based on the second keyword.

6. The method of claim 1, further comprising:
obtaining a second search query including a second keyword;
determining, using the relational database, a second data record location based on the second keyword;
identifying a second data record based on the second data record location;
executing a batch data retrieval job to retrieve the first data record and the second data record; and
providing the second data record as a matching record responsive to the second search query.

6. The method of claim 1, further comprising: acknowledging that the first search query has a first matching record store on the DFS.

7. The method of claim 6, wherein the acknowledging occurs as part of a stream data processing job.

8. The method of claim 1, wherein the DFS system includes a Hadoop database and the relational database is a SQL database.

9. The method of claim 1, wherein the one or more keywords include a plurality of keywords.

10. A system, comprising:
a non-transitory memory; and
one or more hardware processors coupled to the non-transitory memory and configured to execute instructions to perform operations comprising:
receiving a first search query including a first keyword;
receiving a second search query including a second keyword;
accessing a relational database that stores a mapping between one or more keywords and a data record location associated with a distributed file system (DFS), wherein the data record location identifies a location on the DFS at which a data record matching the one or more keywords is stored;
determining, using the relational database, a first data record location based on the first keyword and a second data record location based on the second keyword;
identifying a first data record based on the first data record location and a second data record based on the second data record location; and
performing a batch data processing job to retrieve the first data record and the second data record from the DFS.

11. The system of claim 10, wherein the operations further comprise:
retrieving the first data record from a first data node associated with the DFS; and
retrieving the second data record from a second data node associated with the DFS.

12. The system of claim 10, wherein the operations further comprising: responsive to determining the first data record location and the second data record location, acknowledging that matching records exist for the first search query and the second search query.

13. The system of claim 10, wherein receiving the first search query and receiving the second search query are part of a stream data processing job.

14. The system of claim 10, wherein the first data record and the second data records are greater than a predefined file size.

16. A non-transitory machine-readable medium having stored thereon machine-readable instructions executable to cause a machine to perform operations comprising:
obtaining a first search query including a first keyword;
obtaining a second search query including a second keyword;
accessing a relational database that stores a mapping between one or more keywords and a data record location associated with a distributed file system (DFS), wherein the data record location identifies a location on the DFS at which a data record matching the one or more keywords is stored;
determining, using the relational database, a first data record location based on the first keyword and a second data record location based on the second keyword;
identifying a first data record based on the first data record location and a second data record based on the second data record location; and
performing a batch data processing job to retrieve the first data record and the second data record from the DFS.

16. The non-transitory machine-readable medium of claim 16, wherein performing the batch data processing job comprises:
requesting a name node to retrieve the first data record based on the first data record location and to retrieve the second data record based on the second data record location.

17. The non-transitory machine-readable medium of claim 16, wherein the operations further comprise:
retrieving the first data record and the second data record from a same data node associated with the DFS.

18. The non-transitory machine-readable medium of claim 16, wherein the first query includes a request to modify the first data record based on the first keyword.

19. The non-transitory machine-readable medium of claim 16, wherein the one or more keywords include a plurality of keywords.

20. The non-transitory machine-readable medium of claim 16, wherein the DFS system includes a Hadoop database and the relational database is a SQL database.
